(19) United States
(12) Patent Application Publication
(10) Pub. No.: US 2025/0167450 A1
(43) Pub. Date: May 22, 2025

(54) ANTENNA AND COMMUNICATION DEVICE

(71) Applicant: HUAWEI TECHNOLOGIES CO., LTD., Shenzhen (CN)

(72) Inventors: Chen-Fang Tai, Taipei (TW); Chih-Wei Hsu, Taipei (TW); Chien-Ming Lee, Taipei (TW); En Tso Yu, Taipei (TW)

(73) Assignee: HUAWEI TECHNOLOGIES CO., LTD., Shenzhen (CN)

(21) Appl. No.: 19/026,184

(22) Filed: Jan. 16, 2025

Related U.S. Application Data
(63) Continuation of application No. PCT/CN2023/107483, filed on Jul. 14, 2023.

(30) Foreign Application Priority Data
Jul. 21, 2022 (CN) 202210862709.7

(51) Int. Cl. H01Q 5/48; H01Q 9/04

(52) U.S. Cl. CPC H01Q 5/48; H01Q 9/0414; H01Q 9/0457

(57) ABSTRACT

An antenna includes a grounding plate; a first electric dipole; a first feeding unit, where the first feeding unit includes a first coupling structure coupled to the first electric dipole, and the first feeding unit performs coupled feeding on the first electric dipole through the first coupling structure; a second electric dipole, where the second electric dipole is disposed between the first electric dipole and the grounding plate; a second feeding unit, where the second feeding unit includes a second coupling structure coupled to the second electric dipole, and the second feeding unit performs coupled feeding on the second electric dipole through the second coupling structure; and a magnetic dipole, where the magnetic dipole is electrically connected to the grounding plate, the first electric dipole, and the second electric dipole.

### CROSS-REFERENCE TO RELATED APPLICATIONS

This application is a continuation of International Patent Application No. PCT/CN2023/107483, filed on Jul. 14, 2023, which claims priority to Chinese Patent Application No. 202210862709.7, filed on Jul. 21, 2022. The disclosures of the aforementioned applications are hereby incorporated by reference in their entireties.

### TECHNICAL FIELD

Embodiments of this disclosure relate to the field of communication technologies, and in particular, to an antenna and a communication device.

### BACKGROUND

With development of communication technologies, requirements on mobile phone communication are increasingly high. In a mobile phone, communication of signals in different bands, such as 2G, 3G, 4G, and 5G needs to be implemented. A millimeter wave becomes one of 5G core technologies due to a short wavelength, a wide spectrum, good directivity, and other advantages. To achieve better signal transmission and reception coverage, an antenna of a mobile phone terminal is required to implement good dual-polarized or multi-polarized radiation performance.

However, currently, space left for the antenna is increasingly limited while a mainstream mobile phone terminal develops toward an ultra-thin and bezel-less screen. In the conventional technology, a millimeter-wave antenna has a large thickness, and cannot achieve good radiation performance in limited space of the mobile phone terminal.

### SUMMARY

Embodiments of this disclosure provide an antenna and a communication device, to resolve a problem that a dual-band antenna occupies large space.

To achieve the foregoing objectives, the following technical solutions are used in embodiments of this disclosure.

According to a first aspect of embodiments of this disclosure, an antenna is provided. The antenna includes: a grounding plate; a first electric dipole; a first feeding unit, where the first feeding unit includes a first coupling structure coupled to the first electric dipole, and the first feeding unit performs coupled feeding on the first electric dipole through the first coupling structure; a second electric dipole, where the second electric dipole is disposed between the first electric dipole and the grounding plate; a second feeding unit, where the second feeding unit includes a second coupling structure coupled to the second electric dipole, and the second feeding unit performs coupled feeding on the second electric dipole through the second coupling structure; and a magnetic dipole, where the magnetic dipole is electrically connected to the grounding plate, the first electric dipole, and the second electric dipole. The antenna may be divided into two radiating elements: a first radiating element and a second radiating element that may operate in different frequency bands, where the first radiating element includes the first electric dipole and the magnetic dipole, and the second radiating element includes the first electric dipole, the second electric dipole, and the magnetic dipole. In this way, the second electric dipole is disposed between the first electric dipole and the grounding plate, so that the first radiating element and the second radiating element share an aperture; and the second electric dipole is connected to the first radiating element through the magnetic dipole, so that the first radiating element and the second radiating element share a radiator. This saves space for the antenna, and facilitates miniaturization of the antenna. In addition, in the antenna, an electric dipole and a magnetic dipole form a magneto-electric dipole. A magneto-electric dipole in a horizontal direction and a magneto-electric dipole in a vertical direction can be excited simultaneously, to implement dual-polarized performance and achieve good radiation performance of the antenna.

In an embodiment, an included angle between a projection of the first coupling structure on the grounding plate and a projection of the second coupling structure on the grounding plate is 45°. In this way, an included angle between polarization directions of the first radiating element and the second radiating element is 45°. This improves isolation between the first radiating element and the second radiating element.

In an embodiment, the first feeding unit further includes a first vertical arm and a first feeding end, where the first vertical arm is configured to connect the first coupling structure and the first feeding end, and the first coupling structure and the first vertical arm form an inverted L-shaped structure; and the second feeding unit further includes a second vertical arm and a second feeding end, where the second vertical arm is configured to connect the second coupling structure and the second feeding end, and the second coupling structure and the second vertical arm form an inverted L-shaped structure. In this way, the first vertical arm may be configured to support the first coupling structure, and the second vertical arm may be configured to support the second coupling structure.

In an embodiment, the antenna further includes a first dielectric layer, a second dielectric layer, and a third dielectric layer that are stacked, where a first radiator and the first coupling structure are respectively disposed on two opposite surfaces of the first dielectric layer; a second radiator and the second coupling structure are respectively disposed on two opposite surfaces of the second dielectric layer; and the grounding plate is disposed on a surface that is of the third dielectric layer and that is away from the second dielectric layer. In this way, only three metal layers are required to implement an antenna function, and the antenna has a good low profile. This facilitates miniaturization development of the antenna.

In an embodiment, the first radiator includes four radiation patches, the four radiation patches are symmetrical with respect to a central axis of the first radiating element, and there is a cross-shaped slot between the four radiation patches; and the second radiator includes four radiation arms, and the four radiation arms are symmetrical with respect to a central axis of the second radiating element. Therefore, the four radiation patches may be used as the first electric dipole, and the four radiation arms may be used as the second electric dipole.

In an embodiment, the first coupling structure is opposite to one slot between the four radiation patches, and the second coupling structure is opposite to two radiation arms on a same straight line. Therefore, the first electric dipole and the second electric dipole operate in a differential mode.

In an embodiment, the first feeding unit further includes a third coupling structure, and the third coupling structure is coupled to another slot between the four radiation patches. The second feeding unit further includes a fourth coupling structure, where the fourth coupling structure is coupled to the other two radiation arms of the second radiator, and an included angle between a projection of the third coupling structure on the grounding plate and a projection of the fourth coupling structure on the grounding plate is 45°. Therefore, the first electric dipole and the second electric dipole may operate in a common mode.

In an embodiment, the first feeding unit further includes a third vertical arm and a third feeding end, where the third vertical arm is configured to connect the third coupling structure and the third feeding end, and the third coupling structure and the third vertical arm form an inverted L-shaped structure; and the second feeding unit further includes a fourth vertical arm and a fourth feeding end, where the fourth vertical arm is configured to connect the fourth coupling structure and the fourth feeding end, and the fourth coupling structure and the fourth vertical arm form an inverted L-shaped structure. In this way, the third vertical arm may be configured to support the third coupling structure, and the fourth vertical arm may be configured to support the fourth coupling structure.

In an embodiment, the antenna further includes a fourth dielectric layer and a fifth dielectric layer, where the fourth dielectric layer is disposed between the first coupling structure and the third coupling structure, and the fifth dielectric layer is disposed between the second coupling structure and the fourth coupling structure. In this way, only five metal layers are required to implement an antenna function, and the antenna has a good low profile. This facilitates miniaturization development of the antenna.

In an embodiment, the antenna includes a first filter circuit, and the first filter circuit includes a first inductive member connected in series to the first feeding unit. In this way, isolation between the first radiating element and the second radiating element can be improved.

In an embodiment, the first filter circuit further includes a first capacitive member connected in parallel to the first feeding unit. In this way, isolation between the first radiating element and the second radiating element can be improved.

In an embodiment, the second radiating element includes a second filter circuit, and the second filter circuit includes a second capacitive member connected in series to the second feeding unit. In this way, isolation between the first radiating element and the second radiating element can be improved.

In an embodiment, the magnetic dipole includes a plurality of conductive pillars electrically connected to the first electric dipole and the second electric dipole, and a slot enclosed by the plurality of conductive pillars. In this way, when the conductive pillar is grounded, the conductive pillar may also be used as a magnetic dipole, and is used for both the first radiating element and the second radiating element.

In an embodiment, the conductive pillar includes a first connection part and a second connection part, where the second electric dipole includes a first end and a second end that are opposite to each other, the first end is electrically connected to the first electric dipole through the first connection part, and the second end is electrically connected to the grounding plate through the second connection part. In this way, the conductive pillar implements a magnetic dipole function.

According to a second aspect of embodiments of this disclosure, a communication device is provided, including a radio frequency module and the antenna element according to any one of the foregoing implementations, where the radio frequency module is electrically connected to the antenna. In this way, the communication device can be miniaturized by using the foregoing antenna.

In an embodiment, the communication device includes a rear housing, and at least one radiator of the antenna element is disposed on the rear housing. In this way, the antenna may be disposed on the back of the communication device, and occupies less space.

In an embodiment, the communication device further includes a middle frame, the middle frame includes a bearing plate and a side frame around the bearing plate, and at least one radiator of the antenna element is disposed on the side frame. In this way, the antenna may be disposed on the side frame of the communication device, and occupies less space.

In an embodiment, a printed circuit board PCB is disposed on the bearing plate, and the first feeding unit, the second feeding unit, and the grounding plate are disposed on the PCB. In this way, the feeding unit and the grounding plate of the antenna may be integrated on the circuit board for higher integration. This facilitates further miniaturization of the communication device.

Embodiments of this disclosure disclose an antenna and a communication device. The antenna includes: a grounding plate; a first electric dipole; a first feeding unit, where the first feeding unit includes a first coupling structure coupled to the first electric dipole, and the first feeding unit performs coupled feeding on the first electric dipole through the first coupling structure; a second electric dipole, where the second electric dipole is disposed between the first electric dipole and the grounding plate; a second feeding unit, where the second feeding unit includes a second coupling structure coupled to the second electric dipole, and the second feeding unit performs coupled feeding on the second electric dipole through the second coupling structure; and a magnetic dipole, where the magnetic dipole is electrically connected to the grounding plate, the first electric dipole, and the second electric dipole. In this way, the first electric dipole and the second electric dipole share an aperture, and the first electric dipole is shared. This saves more space for the antenna, and is conducive to miniaturization of the antenna.

### BRIEF DESCRIPTION OF DRAWINGS

FIG. 1 is a diagram of a structure of a communication device according to an embodiment of this disclosure;

FIG. 2a is a diagram of a disassembly structure of a communication device according to an embodiment of this disclosure;

FIG. 2b is a radiation pattern of an antenna in a communication device according to an embodiment of this disclosure;

FIG. 3a is a simplified diagram of an antenna;

FIG. 3b is a simplified diagram of another antenna;

FIG. 4a is a simplified diagram of an antenna according to an embodiment of this disclosure;

FIG. 4b is a diagram of a structure of an antenna according to an embodiment of this disclosure;

FIG. 5 is a main view of the antenna in FIG. 4b;

FIG. 6 is a top view of the antenna in FIG. 4b;

FIG. 7 is an electric field diagram of a first radiating element in FIG. 4b;

FIG. 8 is a distribution diagram of electric fields on a surface of a first electric dipole in FIG. 4b;

FIG. 9 is an electric field diagram of a second radiating element in FIG. 4b;

FIG. 10 is a distribution diagram of electric fields on a surface of a second electric dipole in FIG. 4b;

FIG. 11 is an equivalent circuit diagram of the antenna in FIG. 4b;

FIG. 12 is a simulation curve diagram of antenna isolation varying with a frequency according to Example 1;

FIG. 13 is a simulation curve diagram of antenna efficiency varying with a frequency according to Example 1;

FIG. 14 is an antenna pattern corresponding to a case in which the antenna operates in a first frequency band according to Example 1;

FIG. 15 is an antenna pattern corresponding to a case in which an antenna operates in a second frequency band according to Example 1;

FIG. 16 is a diagram of a structure of another antenna according to an embodiment of this disclosure;

FIG. 17 is a top view of the antenna in FIG. 16;

FIG. 18 is a partial three-dimensional diagram of the antenna in FIG. 16;

FIG. 19 is a main view of the antenna in FIG. 16;

FIG. 20 is a simulation curve diagram of antenna isolation varying with a frequency according to Example 2;

FIG. 21 is a simulation curve diagram of antenna efficiency varying with a frequency according to Example 2;

FIG. 22 is an antenna pattern of a second radiating element in a magnetic field mode according to Example 2;

FIG. 23 is an antenna pattern of a second radiating element in an electric field mode according to Example 2;

FIG. 24 is a diagram of a structure of a first electric dipole;

FIG. 25 is another simulation curve diagram of antenna isolation varying with a frequency according to Example 2;

FIG. 26 is another simulation curve diagram of an antenna system gain varying with a frequency according to Example 2;

FIG. 27 is a diagram of a structure of an antenna array according to an embodiment of this disclosure;

FIG. 28 is a simulation curve diagram of isolation of an antenna array shown in FIG. 27 varying with a frequency;

FIG. 29 is a simulation curve diagram of a system gain of an antenna array shown in FIG. 27 varying with a frequency; and

FIG. 30 is a diagram of an architecture of a communication device according to an embodiment of this disclosure.

### DESCRIPTION OF EMBODIMENTS

To make objectives, technical solutions, and advantages of this disclosure clearer, the following further describes this disclosure in detail with reference to the accompanying drawings.

The following terms “first”, “second”, and the like are merely intended for a purpose of description, and shall not be understood as an indication or implication of relative importance or implicit indication of a quantity of indicated technical features. Therefore, a feature limited by “first”, “second”, or the like may explicitly or implicitly include one or more features. In the descriptions of this disclosure, unless otherwise specified, “a plurality of” means two or more.

In addition, in this disclosure, orientation terms such as “up” and “down” are defined relative to orientations of schematic placement of components in the accompanying drawings. It should be understood that these directional terms are relative concepts, are used for relative description and clarification, and may be correspondingly changed based on changes in placement orientations of the components in the accompanying drawings.

The following describes terms that may appear in embodiments of this disclosure.

Electrical connection: The electrical connection may be understood as that components are in physical contact and electrically conductive, or may be understood as that different components in a line structure are connected through a physical line that can transmit an electrical signal, for example, a PCB copper foil or a conductor. The “connection” refers to a connection of a mechanical structure or a connection of a physical structure.

Coupling: The coupling is a phenomenon that two or more circuit elements or electrical networks closely cooperate with and affect each other in input and output, so that energy is transmitted from one side to another side through interaction.

Antenna pattern: The antenna pattern is also referred to as a radiation pattern. The antenna pattern refers to a pattern in which relative field strength (a normalized modulus value) of an antenna radiation field changes with a direction at a specific distance from the antenna. The antenna pattern is usually represented by two plane patterns that are perpendicular to each other in a maximum radiation direction of an antenna.

Antenna return loss: The antenna return loss may be understood as a ratio of power of a signal reflected back to an antenna port through an antenna circuit to transmit power of the antenna port. A smaller reflected signal indicates a larger signal radiated by the antenna to space and higher radiation efficiency of the antenna. A larger reflected signal indicates a smaller signal radiated by the antenna to space and lower radiation efficiency of the antenna.

The antenna return loss may be represented by an S11 parameter, and the S11 parameter is usually a negative number. A smaller S11 parameter indicates a smaller return loss of the antenna and higher radiation efficiency of the antenna. A larger S11 parameter indicates a larger return loss of the antenna and lower radiation efficiency of the antenna.

Antenna system efficiency: The antenna system efficiency is a ratio of power radiated by the antenna to space (namely, power that is effectively converted into an electromagnetic wave) to power input to the antenna.

Antenna radiation efficiency: The antenna radiation efficiency is a ratio of power radiated by the antenna to space (namely, power that is effectively converted into an electromagnetic wave) to active power input to the antenna. Active power input to the antenna=Input power of the antenna−antenna loss. The antenna loss mainly includes an ohmic loss and/or a dielectric loss of metal.

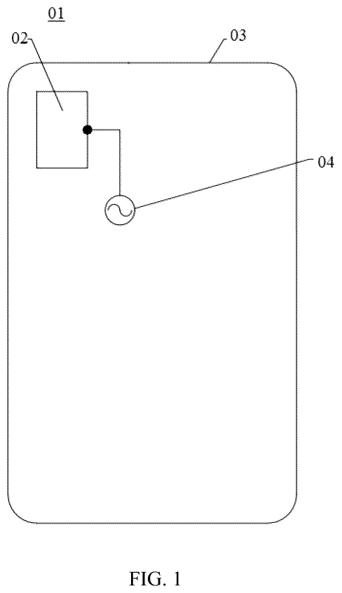

FIG. 1 is a diagram of a structure of a communication device 01 according to an embodiment of this disclosure.

The communication device 01 provided in embodiments of this disclosure includes but is not limited to an electronic product having a wireless communication function, like a mobile phone, a tablet computer, a computer, or a wearable device. The communication device 01 includes an antenna element 02, a device body 03, and a radio frequency module 04.

Both the antenna element 02 and the radio frequency module 04 are assembled on the device body 03. The radio frequency module 04 is electrically connected to the antenna element 02, and is configured to receive and send an electromagnetic signal to the antenna element 02 through a feeding point. The antenna element 02 radiates an electromagnetic wave based on the received electromagnetic signal or sends an electromagnetic signal to the radio frequency module 04 based on a received electromagnetic wave, so as to implement radio signal receiving and sending. The radio frequency module (Radio Frequency module, AF module) 04 is a circuit, like a transmitter and/or receiver (transmitter and/or receiver, T/R) that can transmit and/or receive a radio frequency signal.

A specific form of the communication device 01 is not specially limited in embodiments of this disclosure. For ease of description, the following embodiments are all described by using an example in which the communication device is a mobile phone.

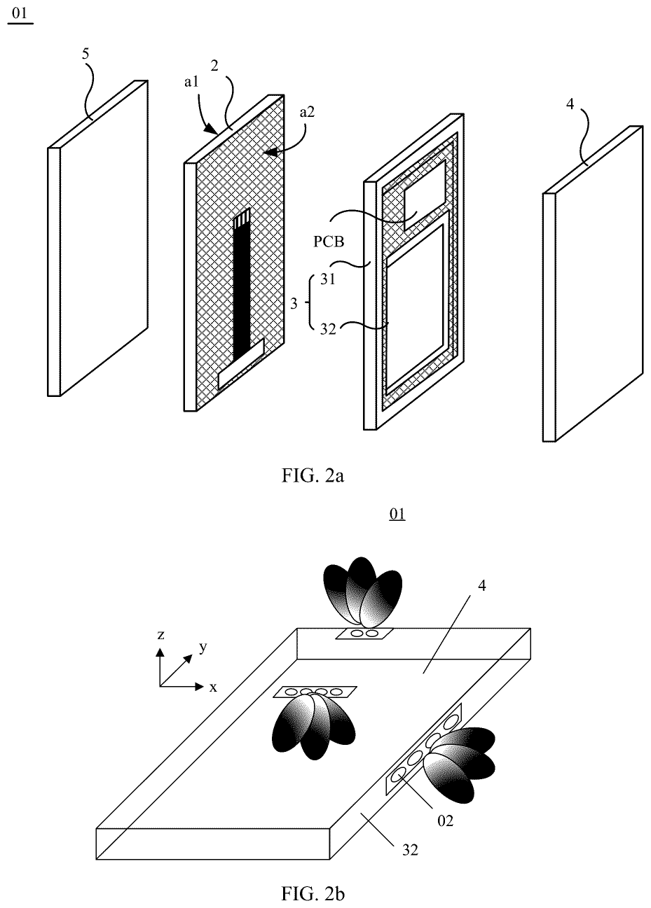

As shown in FIG. 2a, the communication device 01 includes a display 2, a middle frame 3, a back housing (or referred to as a battery cover or a rear housing) 4, and a cover plate 5.

The display 2 has a display surface a1 on which a display image can be seen and a back surface a2 disposed opposite to the display surface a1. The back surface a2 of the display 2 is close to the middle frame 3, and the cover plate 5 is disposed on the display surface a1 of the display 2.

In an embodiment of this disclosure, the display 2 is an organic light-emitting diode (organic light-emitting diode, OLED) display. Because an electroluminescent layer is disposed in each light-emitting subpixel in the OLED display, the OLED display can implement self-luminance after receiving an operating voltage.

In some other embodiments of this disclosure, the display 2 may be a liquid crystal display (liquid crystal display, LCD). In this case, the communication device 01 may further include a backlight module (backlight unit, BLU) configured to provide a light source for the liquid crystal display.

The cover plate 5 is located on a side that is of the display 2 and that is away from the middle frame 3. The cover plate 5 may be, for example, a cover glass (cover glass, CG) or a transparent ceramic material. The cover glass may have specific toughness.

The back housing 4 may be made of a material the same as that of the cover plate 5.

The middle frame 3 is located between the display 2 and the back housing 4. The middle frame 3 includes a bearing plate 31 and a side frame 32 around the bearing plate 31. A surface that is of the middle frame 3 and that is away from the display 2 is used to install internal components such as a battery, a printed circuit board (printed circuit board, PCB), a camera (camera), and an antenna. After the back housing 4 covers the middle frame 3, the internal components are located between the back housing 4 and the middle frame 3.

In some embodiments, as shown in FIG. 2b, the antenna element 02 may be disposed on the side frame 32 and the back housing 4.

A thickness of the side frame 32 is small. A width w of the antenna element 02 is limited by an overall thickness T of the mobile phone for disposing the antenna element 02 on the side frame 32.

For example, a thickness w of the antenna element 02 disposed on the side frame 32 needs to be less than 4 mm.

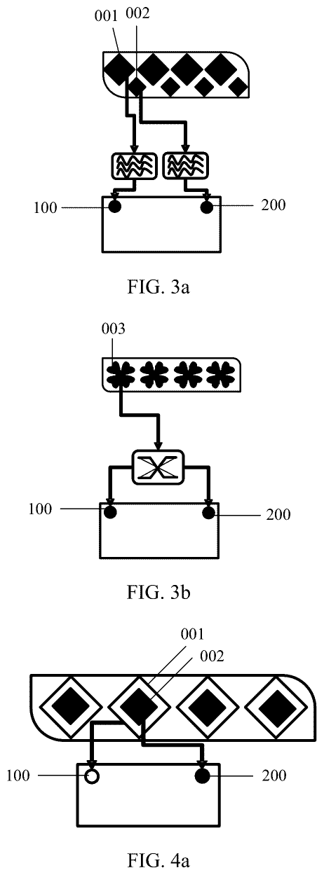

FIG. 3a is a simplified diagram of an antenna. As shown in FIG. 3a, the antenna includes a first feeding unit 100, a second feeding unit 200, a first radiating element 001, and a second radiating element 002. The first radiating element 10 and the second radiating element are located on a same plane and have a simple structure, but occupy large space, which is unfavorable to miniaturization of a device.

FIG. 3b is a simplified diagram of another antenna. As shown in FIG. 3b, the antenna includes a first feeding unit 100, a second feeding unit 200, and a third radiating element 003. The first feeding unit 100 and the second feeding unit 200 are connected to the third radiating element 30, and the third radiating element is configured to radiate or receive electromagnetic waves in two different frequency bands. Isolation is poor and is difficult to implement.

Therefore, it is difficult for an existing millimeter-wave antenna to meet the foregoing requirements. Therefore, an embodiment of this disclosure provides an improved antenna.

FIG. 4a is a simplified diagram of an antenna according to an embodiment of this disclosure. As shown in FIG. 4a, the antenna is a shared-aperture antenna with separate feeding. The antenna includes a first radiating element 001, a first feeding unit 100, a second radiating element 002, and a second feeding unit 200.

FIG. 4b is a diagram of a structure of an antenna according to an embodiment of this disclosure. Refer to FIG. 4b. The structure of the antenna includes a first electric dipole 101, a first feeding unit 100, a second electric dipole 201, a second feeding unit 200, a magnetic dipole 102, and a grounding plate 103. The first feeding unit 100 includes a first coupling structure 1001 coupled to the first electric dipole 101, and the first feeding unit 100 performs coupled feeding on the first electric dipole 101 through the first coupling structure 1001. The first electric dipole 101 is electrically connected to the grounding plate 103 through the magnetic dipole 102.

The second electric dipole 201 is disposed between the first coupling structure 1001 and the grounding plate 103, the second electric dipole 201 is parallel to the first electric dipole 101, and the magnetic dipole 102 is electrically connected to the grounding plate 103 through the second electric dipole 201.

The magnetic dipole 102 includes a plurality of conductive pillars and a slot enclosed by the plurality of conductive pillars. It should be noted that, when an electric dipole induces a current under an action of a coupling structure to resonate and radiate an electromagnetic wave, conductive pillars may radiate the electromagnetic wave through a slot between the conductive pillars under an action of the current.

The second feeding unit 200 includes a second coupling structure 2001 coupled to the second electric dipole 201, and the second feeding unit 200 performs coupled feeding on the second electric dipole 201 through the second coupling structure 2001.

Refer to FIG. 4b. The magnetic dipole 102 includes a first connection part 1021 and a second connection part 1022, and the second electric dipole 201 is located between the first connection part 1021 and the second connection part 1022.

In some embodiments of this disclosure, the first connection part 1021 and the second connection part 1022 are perpendicular to the first electric dipole 101, and the second electric dipole 201 is parallel to the first electric dipole 101.

The second electric dipole 201 includes a first end and a second end that are opposite to each other. The first end of the second electric dipole 201 is connected to the first electric dipole 101 through the first connection part 1021, and the second end is connected to the grounding plate 103 through the second connection part 1022.

With reference to FIG. 4a and FIG. 4b, the antenna may be divided into two radiating elements: the first radiating element 001 and the second radiating element 002 that may operate in different frequency bands. The first radiating element 001 includes the first electric dipole 101 and the magnetic dipole 102, and the second radiating element includes the first electric dipole 101, the second electric dipole 201, and the magnetic dipole 102.

The first feeding unit 100 is configured to feed a first current, so that the first electric dipole 101 and the magnetic dipole 102 operate in a first frequency band.

The second feeding unit 200 is configured to feed a second current, so that the second electric dipole 201, the first electric dipole 101, and the magnetic dipole 102 simultaneously operate in a second frequency band.

In some embodiments of this disclosure, a minimum frequency in the second frequency band is greater than a maximum frequency in the first frequency band. For example, the first frequency band is 24 GHz to 30 GHz, and the second frequency band is 37 GHz to 43 GHz.

In this way, in the antenna, an electric dipole and a magnetic dipole form a magneto-electric dipole, and a magneto-electric dipole in a horizontal direction and a magneto-electric dipole in a vertical direction can be excited simultaneously, to implement dual-polarized performance and achieve good radiation performance of the antenna. The second electric dipole 201 is disposed between the first electric dipole 101 and the grounding plate 103, so that the first radiating element and the second radiating element share an aperture; and the second electric dipole 201 is connected to the magnetic dipole 102 of the first radiating element, so that the first radiating element and the second radiating element share a radiator. This saves space for the antenna, and facilitates miniaturization of a communication device.

Structures of the first electric dipole 101 and the second electric dipole 201 are not limited in embodiments of this disclosure. In some embodiments, the first electric dipole 101 and the second electric dipole 201 each include four resonate elements.

A specific structure of the resonate element is not limited in embodiments of this disclosure. For example, in some embodiments of this disclosure, each resonate element is a square radiation patch, and a side length of each resonate element is ¼ of a wavelength corresponding to an operating frequency of the antenna.

In some other embodiments of this disclosure, each resonate element is a radiation arm, and four radiation arms are symmetrical with respect to a central axis of the resonate element.

For example, as shown in FIG. 4b, the first electric dipole 101 includes four radiation patches, the four radiation patches are symmetrical with respect to a central axis O of the antenna, and the four radiation patches form a cross-shaped slot. The four radiation patches may be used as two orthogonally polarized electric dipole radiators in a low frequency band, and are also used as two orthogonally polarized electric dipole radiators in a high frequency band.

The second electric dipole 201 includes four radiation arms, and the four radiation arms are symmetrical with respect to the central axis O of the antenna. The four radiation arms may be used as two orthogonally polarized electric dipole radiators in a high frequency band.

In some embodiments of this disclosure, a total length of two adjacent radiation patches corresponds to one half of a wavelength of the first frequency band.

A total length of the two adjacent radiation patches and two radiation arms on a same straight line corresponds to three halves of a wavelength of the second frequency band.

Specific structures of the first feeding unit 100 and the second feeding unit 200 are not limited in embodiments of this disclosure. In some embodiments, the first feeding unit 100 includes the first coupling structure 1001 and a first vertical arm 1002. The first coupling structure 1001 includes a cross arm. The cross arm is disposed close to the first electric dipole 101, and is coupled to the first electric dipole 101. A spacing between the cross arm and the first electric dipole 101 is, for example, less than a preset value. In this way, coupled feeding may be performed on the first electric dipole 101 through the cross arm, and because the spacing between the cross arm and the first electric dipole 101 is less than the preset value, a coupling effect can be improved. The first coupling structure 1001 is coupled to one slot between the four radiation patches, and the first coupling structure 1001 passes through the central axis O of the antenna.

In some embodiments, the first coupling structure 1001 is symmetrical with respect to the central axis O of the antenna.

The first vertical arm 1002 is disposed close to a central axis O of the resonate element, the first vertical arm 1002 is configured to connect the first coupling structure 1001 and the grounding plate 103, and the first vertical arm 1002 and the first coupling structure 1001 form a feeding structure in an inverted L-shaped structure.

The second feeding unit 200 includes a second vertical arm 2002 and a second feeding end, where the second vertical arm 2002 is configured to connect the second coupling structure 2001 and the second feeding end, and the second coupling structure 2001 and the second vertical arm 2002 form an inverted L-shaped structure.

The first coupling structure 1001 is coupled to one slot between the four radiation patches.

The second coupling structure 2001 is coupled to two radiation arms on a same straight line.

An included angle between a projection of the first coupling structure 1001 on the grounding plate and a projection of the second coupling structure 2001 on the grounding plate is 45°.

In this way, when the antenna operates in the first frequency band and operates in the second frequency band, an included angle between polarization directions of electromagnetic waves is about 45°. This improves isolation between the two frequency bands.

In an optional solution, the antenna may further include a bearing layer configured to bear the foregoing metal structures (the first electric dipole 101, the first coupling structure 1001, the grounding plate 103, the second electric dipole 201, and the second coupling structure 2001).

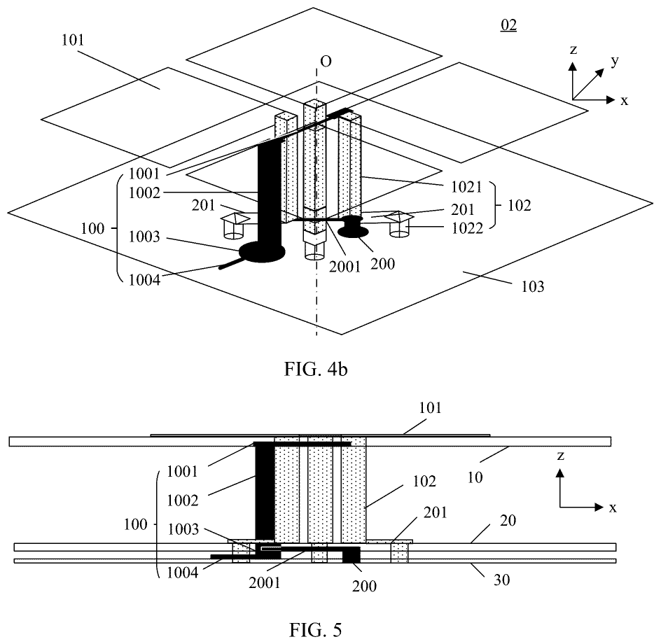

FIG. 5 shows an example of a specific structure of the bearing layer. The bearing layer includes a first dielectric layer 10, a second dielectric layer 20, and a third dielectric layer 30 that are stacked, and the first dielectric layer 10, the second dielectric layer 20, and the third dielectric layer 30 are stacked in a z direction.

The first dielectric layer 10 is configured to bear the first electric dipole 101 and the first coupling structure 1001. The first electric dipole 101 and the first coupling structure 1001 are respectively disposed on two opposite surfaces of the first dielectric layer 10.

The first coupling structure 1001 is disposed on a surface that is of the first dielectric layer 10 and that faces the second dielectric layer 20, and the first electric dipole 101 is disposed on a surface that is of the first dielectric layer 10 and that is away from the second dielectric layer 20.

The first electric dipole 101 and the first coupling structure 1001 may be a metal layer laid on the first dielectric layer 10, or a layer structure formed on two surfaces of the first dielectric layer 10 through vapor deposition. The first dielectric layer 10 supports the first electric dipole 101 and the first coupling structure 1001. This facilitates disposition of the first electric dipole 101 and the first coupling structure 1001.

The first dielectric layer 10 may be made of different materials. For example, the first dielectric layer 10 may be made of common insulation materials such as resin, plastic, and glass.

The second dielectric layer 20 is configured to bear the second electric dipole 201 and the second coupling structure 2001. The second electric dipole 201 and the second coupling structure 2001 are respectively disposed on two opposite surfaces of the second dielectric layer 20.

The second electric dipole 201 is disposed on a surface that is of the second dielectric layer 20 and that faces the first dielectric layer 10. The second coupling structure 2001 is disposed on a surface that is of the second dielectric layer 20 and that is away from the first dielectric layer 10.

The second electric dipole 201 may alternatively be a metal layer laid on the second dielectric layer 20, or a layer structure formed on a surface of the second dielectric layer 20 through vapor deposition. The second dielectric layer 20 may be made of different materials. For example, the second dielectric layer 20 may be made of common insulation materials such as resin, plastic, and glass.

The third dielectric layer 30 is configured to bear the grounding plate 103, and the grounding plate 103 is disposed on a surface that is of the third dielectric layer 30 and that is away from the second dielectric layer 20.

The grounding plate 103 may alternatively be a metal layer laid on the third dielectric layer 30, or a layer structure formed on a surface of the third dielectric layer 30 through vapor deposition. The third dielectric layer 30 may be made of different materials. For example, the third dielectric layer 30 may be made of common insulation materials such as resin, plastic, and glass.

An included angle between a projection of the first coupling structure 1001 on the grounding plate and a projection of the second coupling structure 2001 on the grounding plate is 45°. In this way, an included angle between polarization directions of the first radiating element and the second radiating element is 45°. This improves isolation between the first radiating element and the second radiating element.

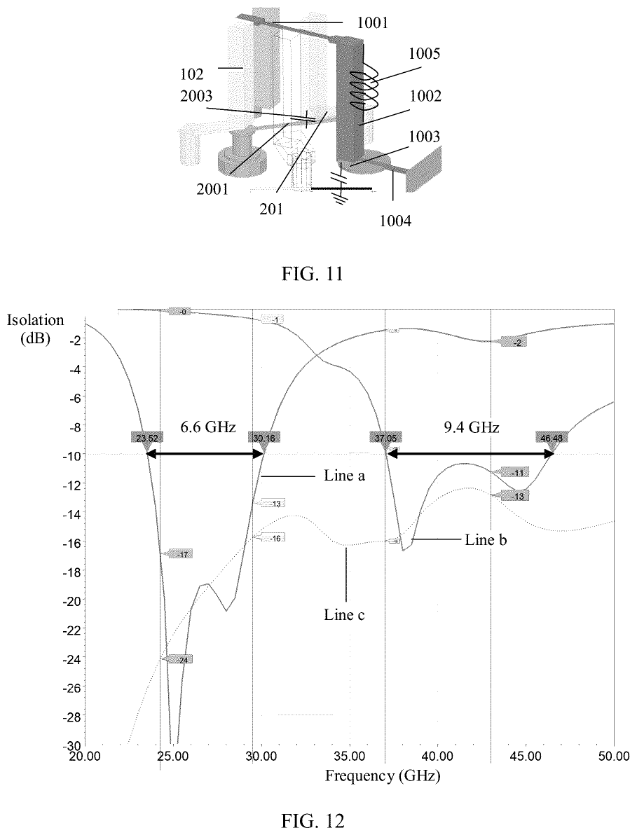

In addition, as shown in FIG. 11, the first radiating element further includes a first filter circuit, and the first filter circuit includes a first inductive member 1005 connected in series and a first capacitive member 1003 connected in parallel, to improve the isolation between the first radiating element and the second radiating element.

The second radiating element further includes a second filter circuit, and the second filter circuit includes a second capacitive member 2003 connected in series.

Feeding structures of the first radiating element and the second radiating element are not limited in embodiments of this disclosure. In some embodiments, the first radiating element and the second radiating element operate in a differential mode (DM), and the first radiating element and the second radiating element are single-polarized antennas.

In some other embodiments, the first radiating element and the second radiating element operate in a common mode (CM), and the first radiating element and the second radiating element are dual-polarized antennas.

The following describes the antenna provided in this embodiment of this disclosure with reference to Example 1 and Example 2.

### Example 1

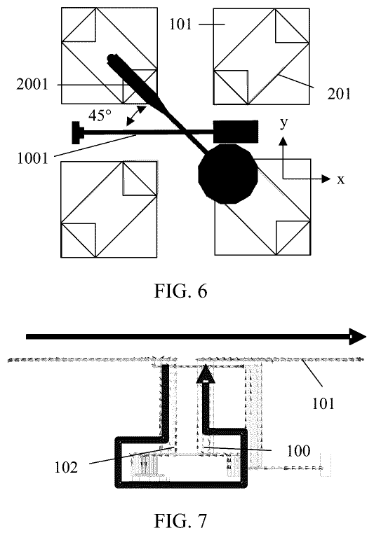

Refer to FIG. 4b, FIG. 5, and FIG. 6. The antenna includes a first radiating element and a second radiating element.

The first radiating element includes a first electric dipole 101, a first feeding unit 100, a magnetic dipole 102, and a grounding plate 103. The first feeding unit 100 includes a first coupling structure 1001 coupled to the first electric dipole 101, and the first feeding unit 100 performs coupled feeding on the first electric dipole 101 through the first coupling structure 1001. The first electric dipole 101 is electrically connected to the grounding plate 103 through the magnetic dipole 102.

The second radiating element includes the first electric dipole 101, a second electric dipole 201, and a second feeding unit 200, where the second feeding unit 200 includes a second coupling structure 2001 coupled to the second electric dipole 201, and the second feeding unit 200 performs coupled feeding on the second electric dipole 201 through the second coupling structure 2001. The second electric dipole 201 is disposed between the first coupling structure 1001 and the grounding plate 103, the second electric dipole 201 is parallel to the first electric dipole 101, and the magnetic dipole 102 is electrically connected to the grounding plate 103 through the second electric dipole 201.

Structures of the first electric dipole 101 and the second electric dipole 201 are not limited in embodiments of this disclosure. For example, the first electric dipole 101 is coupled to the first coupling structure 1001, and the first electric dipole 101 is parallel to the grounding plate 103.

For example, the second electric dipole 201 is coupled to the second coupling structure 2001, and the second electric dipole 201 is parallel to the grounding plate 103.

The first radiating element and the second radiating element may be monopole antennas, that is, the first radiating element and the second radiating element operate in a differential mode (DM).

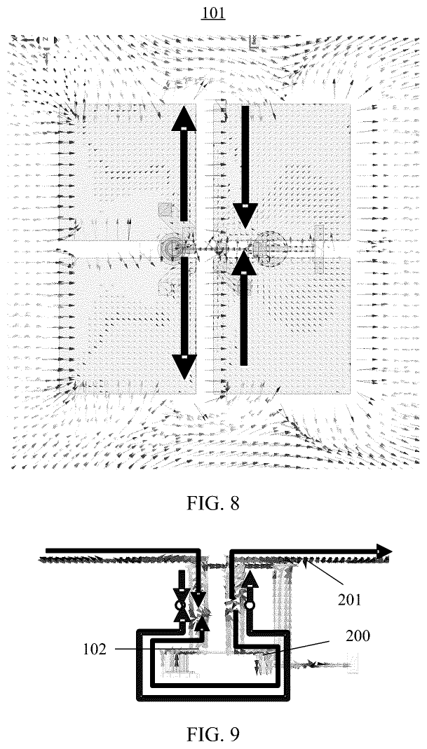

As shown in FIG. 7, currents are asymmetrically fed through the first feeding unit 100. As shown in FIG. 8, currents on the first electric dipole 101 flow asymmetrically. For example, all currents on the first electric dipole 101 flow in a same direction. Therefore, the first electric dipole 101 resonates at a resonance frequency. Excitation electric fields generated by the currents are bidirectional on each side of an antenna resonator. An electric field line is perpendicular to a longitudinal part of the first electric dipole 101. An electric field line of the first feeding unit 100 is from the grounding plate 103 to the first electric dipole 101. It can be learned from FIG. 7 that electric field lines of the first electric dipole 101 on a side of the first feeding unit 100 are in a same direction, that is, are in a direction away from the first electric dipole 101. An electric field line on a side that is of the first electric dipole 101 on the side of the magnetic dipole 102 and that faces the grounding plate 103 is from the first electric dipole 101 to the grounding plate 103. It can be learned from FIG. 7 that electric field lines of the magnetic dipole 102 are in a same direction, that is, are in a direction toward the grounding plate 103. Currents on the first feeding unit 100, the first electric dipole 101, and the magnetic dipole 102 form a loop, and an electrical length is approximately one half of a wavelength corresponding to an operating frequency band of the first radiating element.

It should be noted that, in some embodiments of this disclosure, a metal plate of the first electric dipole 101 uses a square structure, and an aperture of the first electric dipole 101 may be a side length of the metal plate.

In addition, as shown in FIG. 7, when a width of a slot between adjacent conductive pillars is a quarter of the wavelength corresponding to the operating frequency band of the first radiating element, and when the first radiating element operates, the slot between the conductive pillars may be used as a slot antenna, and a resonance frequency is within the operating frequency band of the first radiating element.

Therefore, an operating mode of the first radiating element includes an electric field mode radiated by an electric dipole and a magnetic field mode radiated by the slot between the conductive pillars.

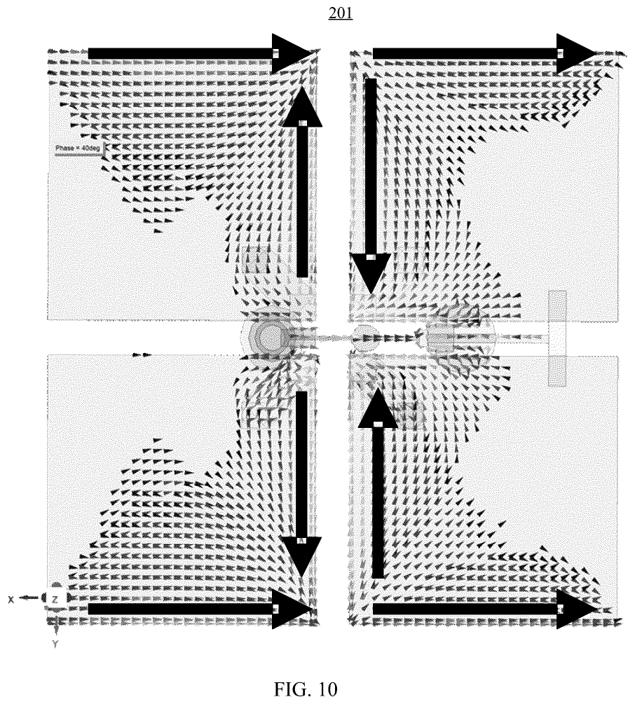

As shown in FIG. 9, currents are asymmetrically fed through a second feeding unit 200. As shown in FIG. 10, currents on the second electric dipole 201 flow asymmetrically. For example, all currents on the second electric dipole 201 flow in a same direction. Therefore, the second electric dipole 201 resonates at a resonance frequency. Excitation electric fields generated by the currents are bidirectional on each side of an antenna resonator. An electric field line is perpendicular to a longitudinal part of the first electric dipole 101. An electric field line of the second feeding unit 200 is from the grounding plate 103 to the second electric dipole 201. It can be learned from FIG. 9 that electric field lines of the second electric dipole 201 on a side of the second feeding unit 200 are in a same direction, that is, are in a direction away from the second electric dipole 201. An electric field line on a side that is of the second electric dipole 201 on the side of the magnetic dipole 102 and that faces the grounding plate 103 is from the second electric dipole 201 to the grounding plate 103. It can be learned from FIG. 9 that electric field lines of the magnetic dipole 102 are in a same direction, that is, are in a direction toward the grounding plate 103. Currents on the second feeding unit 200, the second electric dipole 201, and the magnetic dipole 102 form a loop, and an electrical length is approximately three halves of a wavelength corresponding to an operating frequency band of the second radiating element.

As shown in FIG. 9, when a width of a slot between two conductive pillars disposed along a diagonal is three quarters of the wavelength corresponding to the operating frequency band of the second radiating element, and when the second radiating element operates, the slot between the conductive pillars may be used as a slot antenna, and a resonance frequency is within the operating frequency band of the second radiating element.

Therefore, an operating mode of the second radiating element includes an electric field mode radiated by an electric dipole and a magnetic field mode radiated by the slot between the conductive pillars.

Specific structures of the first feeding unit 100 and the second feeding unit 200 are not limited in embodiments of this disclosure. In some embodiments, the first feeding unit 100 includes a first coupling structure 1001, a first vertical arm 1002, and a first feeding end 1004. The first coupling structure 1001 includes a cross arm. The cross arm is disposed close to the first electric dipole 101, and is coupled to the first electric dipole 101. A spacing between the cross arm and the first electric dipole 101 is, for example, less than a preset value. In this way, coupled feeding may be performed on the first electric dipole 101 through the cross arm, and because the spacing between the cross arm and the first electric dipole 101 is less than the preset value, a coupling effect can be improved.

The first vertical arm 1002 is configured to connect the first coupling structure 1001 and the first feeding end 1004, and the first vertical arm 1002 and the first coupling structure 1001 form a feeding structure of an inverted L-shaped structure.

The second feeding unit 200 includes a second vertical arm 2002 and a second feeding end, the second vertical arm 2002 is configured to connect the second coupling structure 2001 and the second feeding end, and the second coupling structure 2001 and the second vertical arm 2002 form an inverted L-shaped structure.

To improve isolation between the first radiating element and the second radiating element, a filter circuit may be further disposed.

For example, as shown in FIG. 11, the filter circuit includes a first capacitive member 1003, a first inductive member 1005, a second capacitive member 2003, and a third capacitive member 2004.

Refer to FIG. 11. In an equivalent circuit of the first radiating element, the first vertical arm 1002 may be equivalent to the first inductive member 1005, and the first capacitive member 1003 is disposed between the first vertical arm 1002 and the feeding end 100. The first capacitive member 1003 is connected in parallel to the first vertical arm 1002, and the first inductive member 1005 is connected in series to the first feeding unit 100. In other words, the first radiating element is connected in parallel to the first capacitive member 1003, and is connected in series to the first inductive member 1005.

According to a resonant circuit principle, if a capacitance value of the first capacitive member 1003 is C, and an inductance value of the first inductive member 1005 is L, a resonance frequency formula of the first capacitive member 1003 and the first inductive member 1005 is:

f₀=1/2π\sqrt{LC}

The inductance value L of the first inductive member 1005 and the capacitance value C of the first capacitive member 1003 may be adjusted, so that a resonance frequency of the first filter circuit is within the operating frequency band of the first radiating element, a current can flow through the first filter circuit, and the first filter circuit is approximately short-circuited to an operating frequency band of the second radiating element. In this way, a current of the second radiating element cannot flow through the first filter circuit, and the first filter circuit is approximately open-circuited to the second radiating element, so that the first radiating element and the second radiating element do not affect each other.

In addition, still refer to FIG. 11. A coupling circuit between a second coupling structure 2001 and a second electric dipole 201 is equivalent to the second capacitive member 2003, that is, the second capacitive member 2003 is connected in series in a circuit of the second radiating element.

A resonance frequency of the second capacitive member 2003 may be adjusted, so that the current of the second radiating element can pass through the second capacitive member 2003, and the second capacitive member 2003 is approximately short-circuited to the operating frequency band of the first radiating element.

FIG. 12 is a simulation curve diagram of antenna isolation varying with a frequency according to Example 1. A line a is a curve diagram in which S11 of a first radiating element varies with a frequency. Refer to the line a. When the first radiating element resonates, an S11 parameter is small, and an antenna return loss is small. In this case, radiation efficiency of the first radiating element is high.

A line b is a curve diagram in which S11 of a second radiating element varies with a frequency. Refer to the line b. When the second radiating element resonates, an S11 parameter is small, and an antenna return loss is small. In this case, radiation efficiency of the second radiating element is high.

A line c is a curve diagram of isolation of the first radiating element and the second radiating element. Refer to the line c. Isolation of the first radiating element and the second radiating element in an operating frequency band is greater than 15 dB.

A bandwidth of the first radiating element in the operating frequency band is 6.6 GHz, a bandwidth of the second radiating element in the operating frequency band is 9.4 GHz, and the bandwidth is wide.

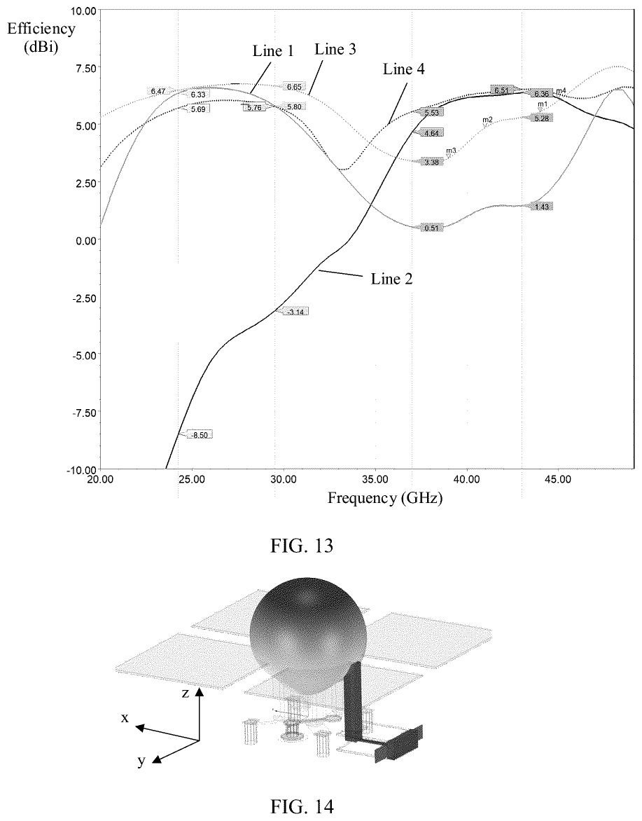

FIG. 13 is a simulation curve diagram of antenna efficiency varying with a frequency according to Example 1. A line 1 is an antenna radiation efficiency curve of a first radiating element. A line 3 is an antenna system efficiency curve of the first radiating element.

When the first radiating element resonates in a frequency band from 24 GHz to 30 GHz, radiation efficiency and system efficiency are greater than 6 dB.

A line 2 is an antenna radiation efficiency curve of a second radiating element, and a line 4 is an antenna system efficiency curve of the second radiating element.

When the second radiating element resonates in a frequency band from 37 GHz to 43 GHz, radiation efficiency and system efficiency are greater than 5 dB.

Refer to the line 1, the line 2, the line 3, and the line 4. A full frequency band gain of the antenna is greater than 5 dB.

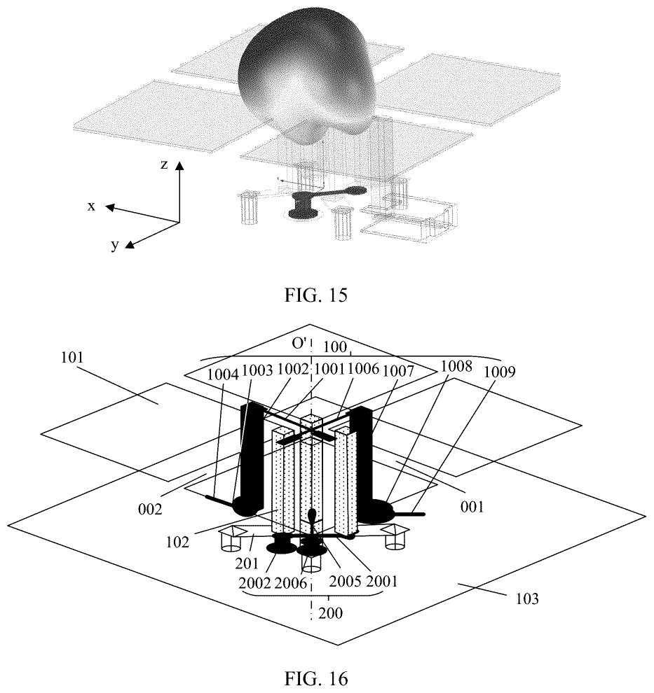

FIG. 14 is an antenna pattern corresponding to a case in which the antenna operates in a first frequency band according to Example 1. FIG. 15 is an antenna pattern corresponding to a case in which the antenna operates in a second frequency band according to Example 1. With reference to FIG. 13, FIG. 14, and FIG. 15, when the antenna is in the first frequency band (24 GHz to 30 GHz), a system gain in a Z direction is the largest, which is about 5.8 dB to 6.3 dB. With reference to FIG. 13, FIG. 14, and FIG. 15, when the antenna is in the second frequency band (37 GHz to 43 GHz), a system gain in the Z direction is the largest, which is about 4.6 dB to 6.4 dB.

### Example 2

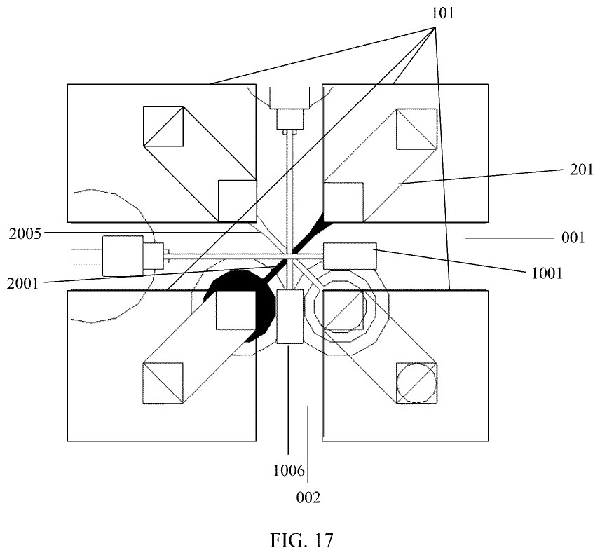

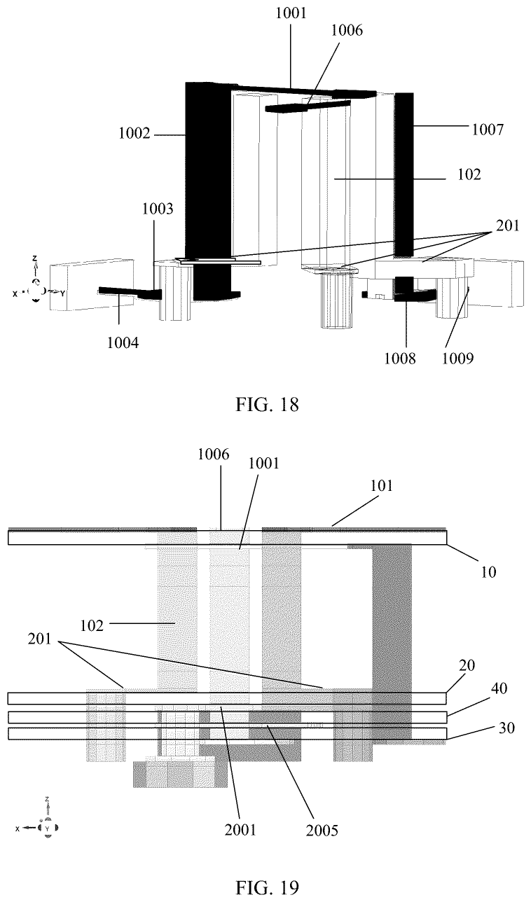

Refer to FIG. 16, FIG. 17, FIG. 18, and FIG. 19. The antenna may be a dual-polarized antenna. The antenna includes a first radiating element and a second radiating element.

The first radiating element includes a first electric dipole 101 and a magnetic dipole 102.

The second radiating element includes the first electric dipole 101, a second electric dipole 201, and the magnetic dipole 102.

The antenna further includes a first feeding unit 100, a second feeding unit 200, and a grounding plate 103, where the first feeding unit 100 includes a first coupling structure 1001 and a third coupling structure 1006 that are coupled to the first electric dipole 101, and the first feeding unit 100 performs coupled feeding on the first electric dipole 101 through the first coupling structure 1001. The first electric dipole 101 is electrically connected to the grounding plate 103 through the magnetic dipole 102.

The second feeding unit 200 includes a second coupling structure 2001 coupled to the second electric dipole 201 and a fourth coupling structure 2005, and the second feeding unit 200 performs coupled feeding on the second electric dipole 201 through the second coupling structure 2001. The second electric dipole 201 is disposed between the first coupling structure 1001 and the grounding plate 103, the second electric dipole 201 is parallel to the first electric dipole 101, and the magnetic dipole 102 is electrically connected to the grounding plate 103 through the second electric dipole 201.

An included angle between a projection of the first coupling structure 1001 on the grounding plate 103 and a projection of the second coupling structure 2001 on the grounding plate 103 is 45°.

An included angle between a projection of the third coupling structure 1006 on the grounding plate 103 and a projection of the fourth coupling structure 2005 on the grounding plate 103 is 45°.

Structures of the first electric dipole 101 and the second electric dipole are not limited in embodiments of this disclosure. For example, the first electric dipole 101 is coupled to the first coupling structure 1001, and the first electric dipole 101 is parallel to the grounding plate 103.

For example, the second electric dipole 201 is coupled to the second coupling structure 2001, and the second electric dipole 201 is parallel to the grounding plate 103.

In some embodiments of this example, the first electric dipole 101 includes four radiation patches, the four radiation patches are symmetrical with respect to a central axis O′ of the antenna, and the four radiation patches form a cross-shaped slot.

In some other embodiments of this disclosure, the first electric dipole 101 includes a pair of symmetrically placed radiation arms.

It should be noted that FIG. 16 and FIG. 17 are described by using an example in which the first electric dipole 101 includes four centrosymmetric resonators. The resonators may be in a shape and structure like a sheet shape, a ring shape, or a column shape. This is not limited in this disclosure.

The following uses an example in which the first electric dipole 101 includes four centrosymmetric resonators for description. The four resonators are symmetrically disposed, a symmetry axis of the four resonators is a central axis between four radiation arms, and the central axis is also the central axis O′ of the antenna. Unless otherwise specified, symmetry axes in a structure mentioned below are the central axis O′ of the antenna.

The second electric dipole 201 includes four radiation arms, and the four radiation arms are symmetrical with respect to the central axis O′ of the antenna.

The first coupling structure is coupled to one slot between the four radiation patches, and the first coupling structure passes through the central axis O′ of the antenna.

In some embodiments, the first coupling structure is symmetrical with respect to the central axis O′ of the antenna.

The third coupling structure 1006 is coupled to another slot between the four radiation patches, and the third coupling structure 1006 passes through the central axis O′ of the antenna.

In some embodiments, the third coupling structure 1006 is symmetrical with respect to the central axis O′ of the antenna.

In addition, an included angle between a projection of the third coupling structure 1006 on the grounding plate and a projection of the first coupling structure on the grounding plate is 90°.

In some embodiments of this example, the first coupling structure 1001 is opposite to a horizontal edge 001 of the cross-shaped slot, and the third coupling structure 1006 is opposite to a longitudinal edge 002 of the cross-shaped slot.

In some other embodiments of this example, the first coupling structure 1001 is disposed opposite to a longitudinal edge of the cross-shaped slot, and the third coupling structure 1006 is disposed opposite to a horizontal edge of the cross-shaped slot.

The second coupling structure 2001 is coupled to two radiation arms on a same straight line.

As shown in FIG. 16 and FIG. 18, the fourth coupling structure 2005 is coupled to the other two radiation arms of the second electric dipole, and an included angle between a projection of the fourth coupling structure 2005 on the grounding plate and a projection of the second coupling structure 2001 on the grounding plate is 90°.

The first feeding unit further includes a first vertical arm 1002, a third vertical arm 1007, a first feeding end 1004, and a third feeding end 1009, where the first vertical arm 1002 is configured to connect the first coupling structure and the first feeding end 1004, and the first coupling structure and the first vertical arm 1002 form an inverted L-shaped structure.

The third vertical arm 1007 is configured to connect the third coupling structure 1006 and the third feeding end 1009, and the third coupling structure 1006 and the third vertical arm 1007 form an inverted L-shaped structure.

The first feeding end 1004 and the third feeding end 1009 are configured to feed currents in different directions, so that the first radiating element radiates electromagnetic waves in two different directions to the outside, to implement dual polarization. In some embodiments, directions of currents fed through the first feeding end 1004 and the third feeding end 1009 are orthogonal, to implement orthogonal polarization.

The second feeding unit further includes a second vertical arm 2002, a fourth vertical arm 2006, a second feeding end, and a fourth feeding end (not shown in the figure). The second vertical arm 2002 is configured to connect the second coupling structure 2001 and the second feeding end, and the second coupling structure 2001 and the second vertical arm 2002 form an inverted L-shaped structure.

The fourth vertical arm 2006 is configured to connect the fourth coupling structure 2005 and the fourth feeding end, and the fourth coupling structure 2005 and the fourth vertical arm 2006 form an inverted L-shaped structure.

The second feeding end and the fourth feeding end are configured to feed currents in different directions, so that the second radiating element radiates electromagnetic waves in two different directions to the outside, to implement dual polarization. In some embodiments, directions of currents fed through the second feeding end and the fourth feeding end are orthogonal, to implement orthogonal polarization.

Based on the foregoing structure, the first radiating element and the second radiating element operate in a common mode (CM).

In the first radiating element, currents are symmetrically fed through the first feeding unit 100. Starting from a position at which the first feeding unit 100 is coupled to the first electric dipole 101, currents symmetrically flow through the antenna resonator in two directions away from the feeding end. Therefore, the antenna resonator resonates at a resonance frequency. Excitation electric fields generated by the currents are unidirectional excitation electric fields on each side of the antenna resonator. An electric field line is perpendicular to a longitudinal part of the first electric dipole 101. Electric field lines on a side of the antenna resonator facing a ground plane are all in a same direction from the first electric dipole 101 to a ground plane 102. Electric field lines on opposite sides of the first electric dipole 101 are all in a same direction away from the first electric dipole 101. Therefore, a CM wire antenna resonator has a radiation pattern polarized in a linear direction. An aperture of the first electric dipole 101 is approximately one half of a wavelength corresponding to an operating frequency band. It should be noted that, in some embodiments of this disclosure, a metal plate of the first electric dipole 101 uses a square structure, and an aperture of the first electric dipole 101 may be a side length of the metal plate.

For a current direction in the second radiating element, refer to that in the foregoing first radiating element. Details are not described herein again.

For operating modes of the first radiating element and the second radiating element, refer to Example 1.

The operating modes of the first radiating element and the second radiating element include an electric field mode radiated by an electric dipole and a magnetic field mode radiated by a slot between conductive pillars.

In addition, as shown in FIG. 19, the antenna further includes a first dielectric layer 10, a second dielectric layer 20, a third dielectric layer 30, and a fourth dielectric layer 40 that are stacked.

The first electric dipole 101 and the first coupling structure 1001 are respectively disposed on two opposite surfaces of the first dielectric layer 10, and the second electric dipole 201 and the second coupling structure 2001 are respectively disposed on two opposite surfaces of the second dielectric layer 20. The grounding plate 103 is disposed on a surface that is of the third dielectric layer 30 and that is away from the second dielectric layer 20.

Heights of the second coupling structure 2001 and the fourth coupling structure 2005 are different. A fourth dielectric layer 40 is disposed between the second coupling structure 2001 and the fourth coupling structure 2005.

It should be noted that a distance between the first coupling structure 2001 and the second electric dipole 201 should be equal to a distance between the fourth coupling structure 2005 and the second electric dipole 201. When the heights of the second coupling structure 2001 and the fourth coupling structure 2005 are different, a thickness of the second electric dipole 201 may be adjusted, so that the distance between the first coupling structure 2001 and the second electric dipole 201 is equal to the distance between the fourth coupling structure 2005 and the second electric dipole 201.

For example, as shown in FIG. 19, a height of the first coupling structure 2001 is higher than a height of the fourth coupling structure 2005, and a thickness of a second electric dipole 201 opposite to the fourth coupling structure 2005 is greater than a thickness of a second electric dipole 201 opposite to the first coupling structure 2001.

In some embodiments, heights of the first coupling structure 1001 and the third coupling structure 1006 are different. A fifth dielectric layer is disposed between the first coupling structure and the third coupling structure 1006.

In some other embodiments, as shown in FIG. 18, the third coupling structure 1006 and the first electric dipole 101 are located at a same layer, and the third coupling structure 1006 and the first electric dipole 101 are located on a same surface of a first dielectric layer.

It should be noted that a person skilled in the art may adjust a quantity of layers of a dielectric layer and a height and a thickness of a coupling structure based on a requirement. All these fall within the protection scope of this disclosure.

Simulation is performed on the antenna provided in Example 2 in the following. For example, a size of the antenna meets the following: a plane size is 3.35 mm*3.35 mm, and a height is 1.1 mm.

The first radiating element operates in a first frequency band, and the second radiating element operates in a second frequency band. Directions of currents through the first feeding end 1004 and the third feeding end 1009 are orthogonal, and directions of currents fed through the second feeding end and the fourth feeding end are orthogonal.

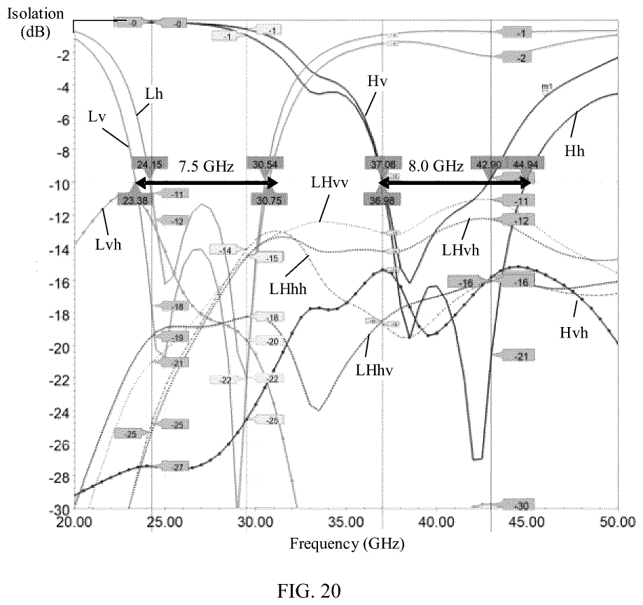

FIG. 20 is a simulation curve diagram of antenna isolation varying with a frequency according to Example 2. An Lv line is an S11 curve of the first feeding end.

An Lh line is an S11 curve of the third feeding end.

Refer to the Lv line and the Lh line. It can be learned that when the first radiating element resonates, an S11 parameter is small, and an antenna return loss is small. In this case, radiation efficiency of the first radiating element is high.

An Hv line is an S11 curve of the second feeding end.

An Hh line is an S11 curve of the fourth feeding end.

Refer to the Hv line and the Hv line. It can be learned that when the second radiating element resonates, an S11 parameter is small, and an antenna return loss is small. In this case, radiation efficiency of the second radiating element is high.

An Lvh line is an isolation curve between the first feeding end and the third feeding end.

An Hvh line is an isolation curve between the second feeding end and the fourth feeding end.

An LHvv line is an isolation curve between the first feeding end and the second feeding end.

An LHhh line is an isolation curve between the third feeding end and the fourth feeding end.

An LHhv line is an isolation curve between the first feeding end and the fourth feeding end.

An LHvh line is an isolation curve between the third feeding end and the second feeding end.

Refer to the Lvh line, the Hvh line, the LHvv line, the LHhh line, the LHhv line, and the LHvh line. It can be learned that isolation of the first radiating element and the second radiating element in the operating frequency band is greater than 10 dB.

A bandwidth of the first radiating element in the operating frequency band is 7.5 GHz, a bandwidth of the second radiating element in the operating frequency band is 8.0 GHz, and the bandwidth is wide.

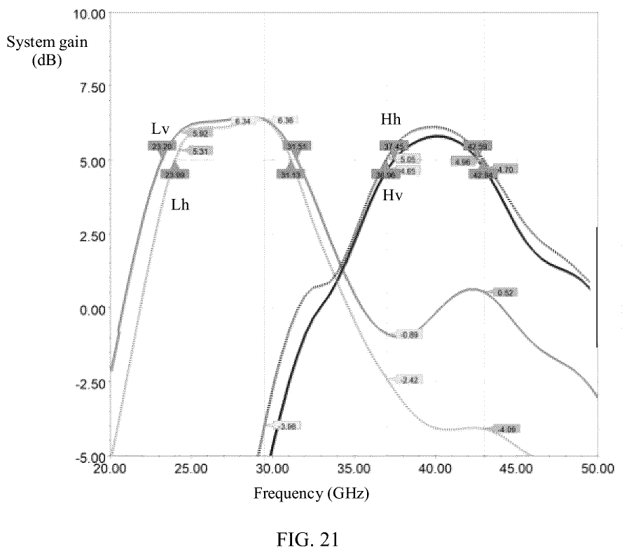

FIG. 21 is a simulation curve diagram of antenna efficiency varying with a frequency according to Example 2. In FIG. 21, an Lv line is a system gain curve of the first radiating element in an electric field mode.

An Lh line is a system gain curve of the first radiating element in a magnetic field mode.

Refer to the Lv line and the Lh line. It can be learned that when the first radiating element resonates, radiation efficiency of the antenna is high.

An Hv line is a system gain curve of the second radiating element in an electric field mode.

An Hh line is a system gain curve of the fourth feeding end.

Refer to the Hv line and the Hh line. It can be learned that when the second radiating element resonates, radiation efficiency of the antenna is high.

A height of the antenna in FIG. 16 to FIG. 21 is 1100 μm. In some embodiments, the height of the antenna may be further reduced. For example, the height of the antenna may be reduced to 900 μm. When the height of the antenna is reduced, the magnetic dipole 102 of the first radiating element becomes shorter, so that electric field strength and magnetic field strength of the first radiating element is high, and an electric field modulus of the second radiating element is high.

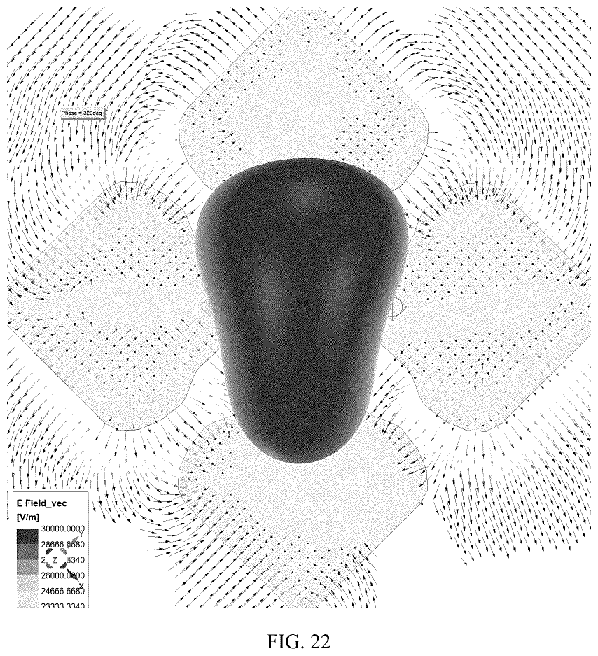

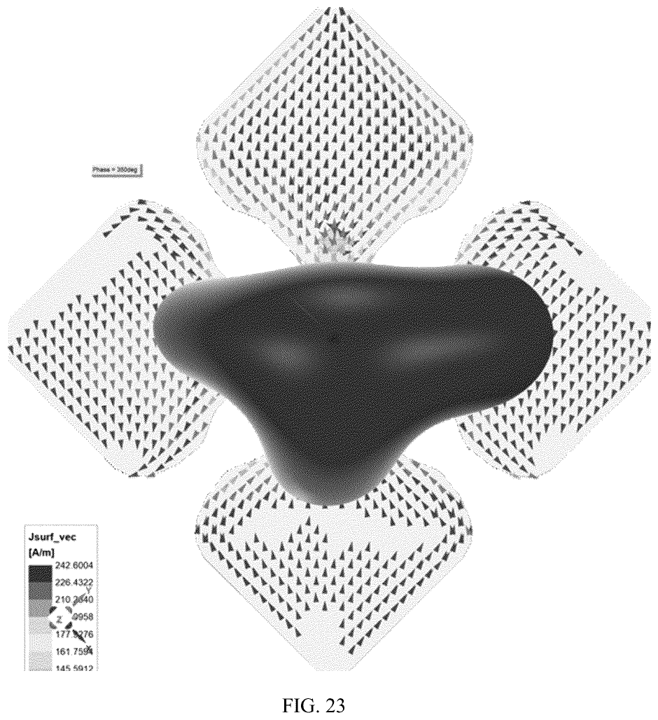

FIG. 22 is an antenna pattern of the fourth feeding end according to Example 2. FIG. 23 is an antenna pattern of the second feeding end according to Example 2.

As shown in FIG. 22, in a slot radiation mode, the antenna pattern has a large longitudinal beam width. As shown in FIG. 23, in an electric field mode, the antenna pattern has a large horizontal beam width.

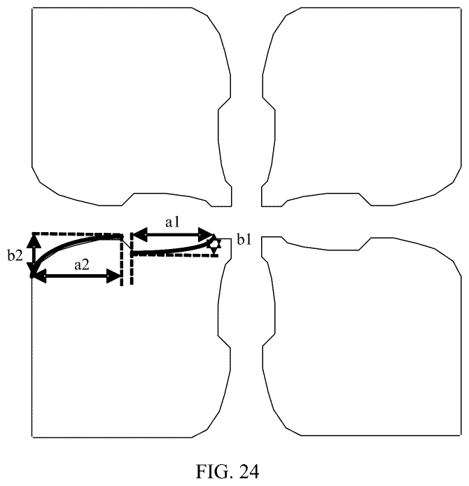

To improve performance of the antenna, a shape of the first electric dipole 101 may be changed, and the first electric dipole 101 is made into a petal shape shown in FIG. 24. A radiation patch of the first electric dipole 101 may be adjusted from a square shape to the petal shape. A position that is of the radiation patch and that is close to a central axis of the petal is in a first arc, and a position that is of the radiation patch and that is away from the central axis of the petal is in a second arc. Bending directions of the first arc and the second arc are opposite. A width of the first arc is b1 and a length of the first arc is a1. A width of the second arc is b2 and a length of the second arc is a2.

An antenna bandwidth may be expanded by performing gradient and circular-arc trimming on an edge of an antenna radiator, and a sharp change of impedance at an edge of an operating frequency band is reduced by performing gradient and circular-arc trimming. This expands an antenna bandwidth (for example, b1 and b2 in this embodiment).

In addition, this operation may further be used to calibrate the pattern. An actual excitation structure of the antenna and a surrounding system environment are not perfectly symmetrical. Therefore, the pattern cannot perfectly radiate in a Z direction in all operating frequency bands. Especially, when approaching the edge of the operating frequency band, the radiation pattern may have an offset, and the offset may be appropriately calibrated through circular-arc trimming (for example, b1 and b2 in this embodiment).

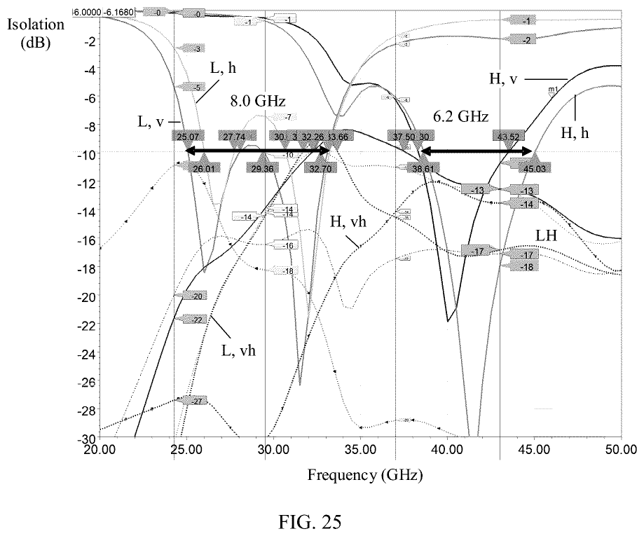

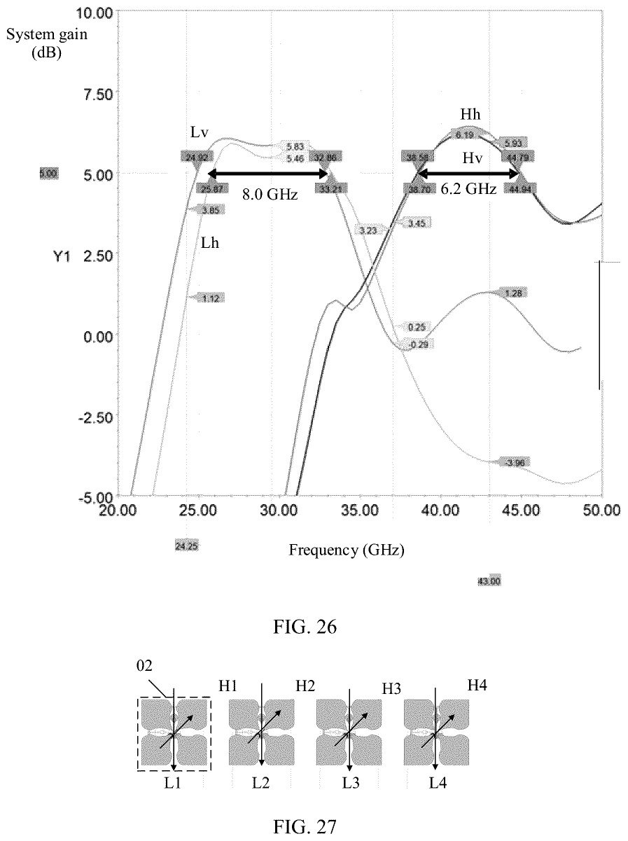

Simulation is performed on another antenna provided in Example 2 in the following. FIG. 25 and FIG. 26 are simulation diagrams after the height of the antenna in Example 2 is reduced to 0.9 mm. For a structure of the first electric dipole 101 of the antenna, refer to FIG. 24. For example, a size of the antenna meets the following: a plane size is 3.35 mm*3.35 mm, and a height is 0.9 mm.

FIG. 25 is another simulation curve diagram of antenna isolation varying with a frequency according to Example 2. When FIG. 20 is compared with FIG. 25, a bandwidth of an operating frequency band (low frequency) of the first radiating element is changed from 7.5 GHz to 8.0 GHz, and the bandwidths are close. A bandwidth of an operating frequency band (high frequency) of the second radiating element is changed from 8.0 GHz to 6.2 GHz, and the bandwidths are slightly reduced. Return losses and isolation of feeding ends (an Lv line, an Lh line, and an Lvh line) corresponding to the first radiating element and the second radiating element (an Hv line, an Hh line, and an Hvh line) basically remain unchanged.

Cross polarization isolation (LH line) of the second radiating element changes from −16 dB to −12 dB.

FIG. 26 is another simulation curve diagram of an antenna system gain varying with a frequency according to Example 2. A system gain (an Lv line, an Lh line) of the first radiating element and a system gain (an Hv line, an Hh line) of the second radiating element are greater than 5 dB.

According to the antenna provided in this embodiment of this disclosure, feeding units of the first radiating element and the second radiating element are separated, and a high-frequency radiating element and a low-frequency radiating element share an aperture. Compared with an antenna with a separate aperture, the antenna provided in this embodiment of this disclosure saves more planar space.

An embodiment of this disclosure further provides an antenna array. FIG. 27 is a diagram of a structure of an antenna array according to this embodiment of this disclosure. As shown in FIG. 27, the antenna array includes four antenna elements 02. The antenna element uses an antenna structure shown in the example.

For example, a size of the antenna array meets the following: a planar size of each antenna element is 3.35 mm*3.35 mm, and a height is 1.1 mm.

An array element spacing of the antenna array is 5.5 mm, where the array element spacing is a distance between centers of adjacent millimeter-wave dual-polarized microstrip antenna elements.

For example, the four antenna elements are disposed side by side, and the antenna array has a length of 16.85 mm and a width of 3.35 mm.

Isolation: cross-polarization isolation of a same radiating element: An average value of isolation between first feeding ends and third feeding ends of a plurality of resonators is −17 dB, and an average value of isolation between second feeding ends and fourth feeding ends of the plurality of resonators is −16 dB.

Isolation between first radiating elements of a plurality of resonators is greater than −14 dB, and isolation between second radiating elements of the plurality of resonators is greater than −12 dB.

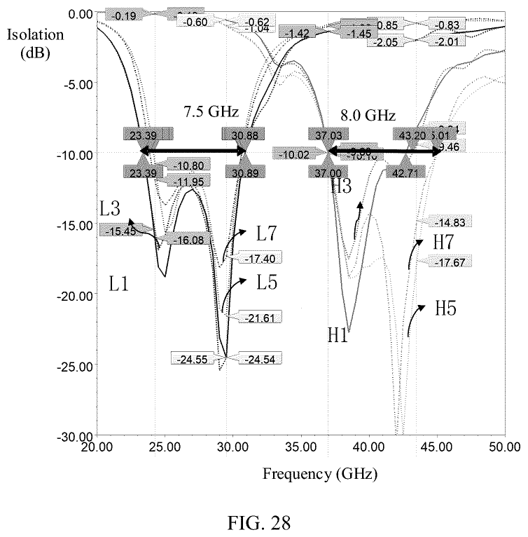

FIG. 28 is a simulation curve diagram of isolation of the antenna array shown in FIG. 27 varying with a frequency. Each curve in FIG. 28 corresponds to each of return losses of first feeding ends and return losses of second feeding ends of four antenna elements in the array.

As shown in FIG. 28, an L1 line is an S11 curve of a first feeding end in a first antenna element, and an H1 line is an S11 curve of a second feeding end in the first antenna element.

An L2 line is an S11 curve of a first feeding end in a second antenna element, and an H2 line is an S11 curve of a second feeding end in the second antenna element.

An L3 line is an S11 curve of a first feeding end in a third antenna element, and an H3 line is an S11 curve of a second feeding end in the third antenna element.

An L4 line is an S11 curve of a first feeding end in a fourth antenna element, and an H4 line is an S11 curve of a second feeding end in the fourth antenna element.

A matching bandwidth of the first radiating element is 7.5 GHz, and a matching bandwidth of the second radiating element is 8.0 GHz.

Isolation between different radiating elements having a same polarization direction: Isolation between first feeding ends of resonators is greater than −11 dB, and isolation between second feeding ends of the resonators is greater than −15 dB.

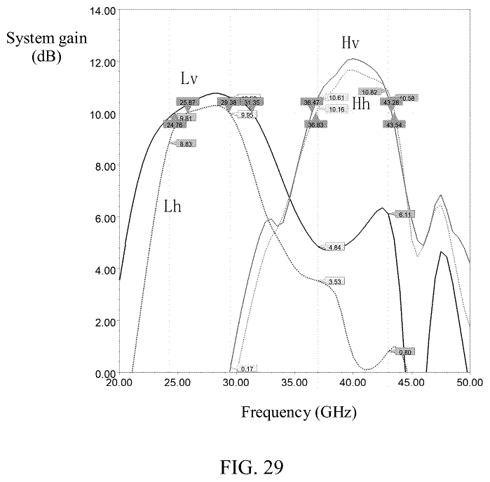

FIG. 29 is a simulation curve diagram of a system gain of the antenna array shown in FIG. 27 varying with a frequency. Each curve in FIG. 29 corresponds to each of system gains of first feeding ends and system gains of second feeding ends of four antenna elements in the array.

As shown in FIG. 29, an average gain of the array is: A system gain of the first radiating element is 10.5 dB, and a system gain of the second radiating element is 11.4 dB.

Scanning angle: A scanning angle of the first radiating element is 131°, and a scanning angle of the second radiating element is 78°.

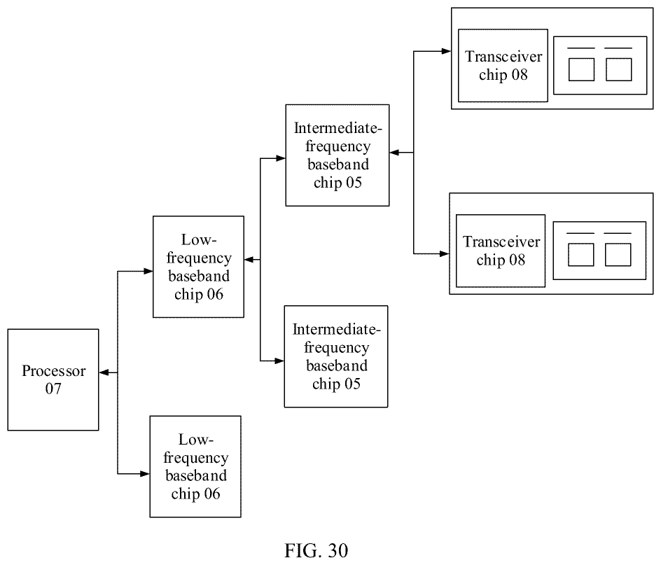

FIG. 30 is a diagram of an architecture of a communication device according to an embodiment of this disclosure.

It should be noted that the antenna element 02 in this disclosure may be further packaged to form a transceiver chip 08 shown in FIG. 30. A transceiver antenna is, for example, a millimeter-wave antenna.

As shown in FIG. 30, in addition to the transceiver chip 08, an intermediate-frequency baseband chip 05, a low-frequency baseband chip 06, and a processor 07 are further disposed in a communication device 01.

One or more low-frequency baseband chips 06 are connected to the processor 07, one or more intermediate-frequency baseband chips 05 are connected to the low-frequency baseband chip 06, and one or more transceiver chips 08 are connected to the intermediate-frequency baseband chip 05.

Embodiments of this disclosure disclose an antenna and a communication device. The antenna includes: a grounding plate; a first electric dipole; a first feeding unit, where the first feeding unit includes a first coupling structure coupled to the first electric dipole, and the first feeding unit performs coupled feeding on the first electric dipole through the first coupling structure; a second electric dipole, where the second electric dipole is disposed between the first electric dipole and the grounding plate; a second feeding unit, where the second feeding unit includes a second coupling structure coupled to the second electric dipole, and the second feeding unit performs coupled feeding on the second electric dipole through the second coupling structure; and a magnetic dipole, where the magnetic dipole is electrically connected to the grounding plate, the first electric dipole, and the second electric dipole. In this way, the first electric dipole and the second electric dipole share an aperture, and the first electric dipole is shared. This saves more space for the antenna, and is conducive to miniaturization of the antenna.

The foregoing descriptions are merely specific implementations of this disclosure, but are not intended to limit the protection scope of this disclosure. Any variation or replacement within the technical scope disclosed in this disclosure shall fall within the protection scope of this disclosure. Therefore, the protection scope of this disclosure shall be subject to the protection scope of the claims.

What is claimed is:

1. An antenna, comprising:
a grounding plate;
a first electric dipole;
a first feeding unit, wherein the first feeding unit comprises a first coupling structure coupled to the first electric dipole, and the first feeding unit performs coupled feeding on the first electric dipole through the first coupling structure;
a second electric dipole, wherein the second electric dipole is disposed between the first electric dipole and the grounding plate;
a second feeding unit, wherein the second feeding unit comprises a second coupling structure coupled to the second electric dipole, and the second feeding unit performs coupled feeding on the second electric dipole through the second coupling structure; and
a magnetic dipole, wherein the magnetic dipole is electrically connected to the grounding plate, the first electric dipole, and the second electric dipole.

2. The antenna according to claim 1, wherein an included angle between a projection of the first coupling structure on the grounding plate and a projection of the second coupling structure on the grounding plate is 45°.

3. The antenna according to claim 1, wherein the first feeding unit further comprises a first vertical arm and a first feeding end, wherein the first vertical arm is configured to connect the first coupling structure and the first feeding end, and the first coupling structure and the first vertical arm form a first inverted L-shaped structure; and
the second feeding unit further comprises a second vertical arm and a second feeding end, wherein the second vertical arm is configured to connect the second coupling structure and the second feeding end, and the second coupling structure and the second vertical arm form a second inverted L-shaped structure.

4. The antenna according to claim 1, further comprising a first dielectric layer, a second dielectric layer, and a third dielectric layer that are stacked, wherein
the first electric dipole and the first coupling structure are respectively disposed on two opposite surfaces of the first dielectric layer;
the second electric dipole and the second coupling structure are respectively disposed on two opposite surfaces of the second dielectric layer; and
the grounding plate is disposed on a surface of the third dielectric layer that is away from the second dielectric layer.

5. The antenna according to claim 1, wherein the first electric dipole comprises four radiation patches, the four radiation patches are symmetrical with respect to a central axis of the antenna, and there is a cross-shaped slot between the four radiation patches; and
the second electric dipole comprises four radiation arms, and the four radiation arms are symmetrical with respect to the central axis of the antenna.

6. The antenna according to claim 5, wherein the first coupling structure is opposite to one slot between the four radiation patches, the first coupling structure passes through the central axis of the antenna, and the second coupling structure is opposite to two radiation arms on a same straight line.

7. The antenna according to claim 6, wherein the first feeding unit further comprises a third coupling structure, the third coupling structure is coupled to another slot between the four radiation patches, and the third coupling structure passes through the central axis of the antenna; and
the second feeding unit further comprises a fourth coupling structure, wherein the fourth coupling structure is coupled to the other two radiation arms of the second electric dipole, an included angle between a projection of the third coupling structure on the grounding plate and the projection of the first coupling structure on the grounding plate is 90°, and an included angle between a projection of the fourth coupling structure on the grounding plate and the projection of the second coupling structure on the grounding plate is 90°.

8. The antenna according to claim 7, wherein the first feeding unit further comprises a third vertical arm and a third feeding end, wherein the third vertical arm is configured to connect the third coupling structure and the third feeding end, and the third coupling structure and the third vertical arm form a third inverted L-shaped structure; and
the second feeding unit further comprises a fourth vertical arm and a fourth feeding end, wherein the fourth vertical arm is configured to connect the fourth coupling structure and the fourth feeding end, and the fourth coupling structure and the fourth vertical arm form a fourth inverted L-shaped structure.

9. The antenna according to claim 7, further comprising a fourth dielectric layer and a fifth dielectric layer, wherein the fourth dielectric layer is disposed between the first coupling structure and the third coupling structure, and the fifth dielectric layer is disposed between the second coupling structure and the fourth coupling structure.

10. The antenna according to claim 1, wherein a first radiating element comprises a first filter circuit, and the first filter circuit comprises a first inductive member connected in series to the first feeding unit.

11. The antenna according to claim 10, wherein the first filter circuit further comprises a first capacitive member connected in parallel to the first feeding unit.

12. The antenna according to claim 1, wherein a second radiating element comprises a second filter circuit, and the second filter circuit comprises a second capacitive member connected in series to the second feeding unit.

13. The antenna according to claim 1, wherein the magnetic dipole comprises a plurality of conductive pillars electrically connected to the first electric dipole and the second electric dipole, and a slot enclosed by the plurality of conductive pillars.

14. The antenna according to claim 13, wherein the conductive pillar comprises a first connection part and a second connection part, wherein the second electric dipole comprises a first end and a second end that are opposite to each other, the first end is electrically connected to the first electric dipole through the first connection part, and the second end is electrically connected to the grounding plate through the second connection part.

15. A communication device, comprising a radio frequency module and an antenna, wherein the radio frequency module is electrically connected to the antenna, and the antenna comprises:
a grounding plate;
a first electric dipole;
a first feeding unit, wherein the first feeding unit comprises a first coupling structure coupled to the first electric dipole, and the first feeding unit performs coupled feeding on the first electric dipole through the first coupling structure;
a second electric dipole, wherein the second electric dipole is disposed between the first electric dipole and the grounding plate;
a second feeding unit, wherein the second feeding unit comprises a second coupling structure coupled to the second electric dipole, and the second feeding unit performs coupled feeding on the second electric dipole through the second coupling structure; and
a magnetic dipole, wherein the magnetic dipole is electrically connected to the grounding plate, the first electric dipole, and the second electric dipole.

16. The communication device according to claim 15, wherein an included angle between a projection of the first coupling structure on the grounding plate and a projection of the second coupling structure on the grounding plate is 45°.

17. The communication device according to claim 15, wherein the first feeding unit further comprises a first vertical arm and a first feeding end, wherein the first vertical arm is configured to connect the first coupling structure and the first feeding end, and the first coupling structure and the first vertical arm form a first inverted L-shaped structure; and
the second feeding unit further comprises a second vertical arm and a second feeding end, wherein the second vertical arm is configured to connect the second coupling structure and the second feeding end, and the second coupling structure and the second vertical arm form a second inverted L-shaped structure.

18. The communication device according to claim 15, wherein the communication device comprises a rear housing, and the antenna is disposed on the rear housing.

19. The communication device according to claim 15, wherein the communication device further comprises a middle frame, the middle frame comprises a bearing plate and a side frame around the bearing plate, and the antenna is disposed on the side frame.

20. The communication device according to claim 19, wherein a printed circuit board (PCB) is disposed on the bearing plate, and the first feeding unit, the second feeding unit, and the grounding plate are disposed on the PCB.
